(19) United States
(12) Patent Application Publication
(10) Pub. No.: US 2007/0273145 A1
(43) Pub. Date: Nov. 29, 2007

(54) Method For The Series Production Of Identification Pages For Bound Documents, Identification Page And Bound Document

(76) Inventors: Stephan Betz, Schneeberg (DE); Anton Brunner, Kotzling (DE); Michael Ried, Kulz (DE)

Correspondence Address: NEEDLE & ROSENBERG, P.C., SUITE 1000, 999 PEACHTREE STREET, ATLANTA, GA, 30309-3915, US

(21) Appl. No.: 10/589,427

(22) PCT Filed: Jan. 31, 2005
(86) PCT No.: PCT/EP05/50389

§ 371 Date: Nov. 3, 2006

(30) Foreign Application Priority Data
Feb. 21, 2004 (DE) 10 2004 008 662.1

(51) Int. Cl. B42D 15/00

(52) U.S. Cl. 283/77

(57) ABSTRACT

The invention relates to a method for the series production of identification pages for bound documents, in particular for passports and/or identity papers, comprising the steps of providing a printed web of printed material comprising a plurality of printed units, forming slot-shaped through-holes which run between the printed units perpendicular to the longitudinal direction of the web, arranging in layers a first film-type web, the printed web and a second, the webs arranged in layers so as to form a composite, and dividing the composite into individual composite units, such that each composite unit has along at least one of its sides a strip which does not comprise any part of the printed web. Also disclosed is an identification page and a bound document comprising such an identification page.

The invention relates to a method for the series production of identification pages for bound documents, in particular for passports and/or identity papers, to an identification page for bound documents, such as passports and/or identity papers, and to a bound document containing such an identification page, according to the preambles of Claims 1, 4, 11, 12 and 14.

Conventionally, bound documents containing person-specific data, such as passports, are provided with at least one page which usually consists of a relatively stiff sheet-like material and has to be permanently arranged within the passport. So-called holder pages such as these are arranged in such booklets in order to display, in a durable manner that is not liable to wear and cannot be falsified, person-specific data such as, for example, the name, address, date of birth and date of registration along with the signature and the passport photograph, and document-specific data such as the issuing authority, the passport number, the date of issue and the period of validity.

Such holder pages are usually produced separately from the hinges which hold them in the passport, by producing an ID card for example by means of a laminating technique as is the case in conventional personal ID cards. To this end, printed units are usually sealed individually in films and then bound into the passport by means of an additionally manufactured hinge.

Conventionally, such hinges are designed as material-like tapes which are already incorporated in the passport during the binding of the passport by means of a sewing operation. This is disclosed for example in EP 1 008 459 B1.

Once the binding operation has taken place, the holder page is positioned at one of its side edges between the tape and another plastic strip which must additionally be provided. For a durable and secure join between the holder page and the actual booklet, it is necessary that the plastic strip is provided for example with local thickened areas or perforations and is connected to the holder page and to the tape in a chemical or physical manner, for example by means of glue. Such a method is time-intensive and cost-intensive and makes it difficult to produce durably secure passports since the join between the holder page and the actual booklet may become detached in the event of frequent use.

Accordingly, the present invention is based on the object of providing methods for the series production of identification pages for bound documents, in particular for passports and/or identity papers, which allow rational, fast and cost-effective production of a plurality of identification pages for such bound documents. Furthermore, the present invention is based on the object of providing identification pages and bound documents comprising such identification pages, which can be produced in a simple, fast and cost-effective manner and also in large numbers.

This object is achieved in terms of the method by Claims 1 and 4 and in terms of the product by Claims 11, 12 and 14.

One essential aspect of the invention consists in that, in a method for the series production of identification pages for bound documents, in particular for passports and/or identity papers, the following steps are carried out:
providing a printed web of printed material comprising a plurality of printed units which are arranged in at least one row;
forming slot-shaped through-holes in the printed web, said through-holes running between the printed units perpendicular to the longitudinal direction of the web;
arranging in layers a first, lower film-type web, the printed web and a second, upper film-type web;
laminating the webs arranged in layers so as to form a composite; and
dividing the composite between the printed units arranged in rows into individual composite units, such that each composite unit has along at least one of its sides a strip which does not comprise any part of the printed web.

Such a method according to the invention makes it possible to fit hinge-like devices in the form of strips at the time of series production of such identification pages (holder pages) for booklets, at which the holder pages are then sewn together with other paper pages during the operation of binding the booklet. In this way, there is no need for any additional time-intensive and cost-intensive booklet production steps, such as the separate sewing-in of hinge-like tapes and the joining of such tapes to the holder pages.

Due to the simultaneous or fast sequential production of a plurality of holder pages, which may be arranged for example within the common printed web (printed sheet of card) in two rows and with at least four arranged one behind the other, that is to say as eight printed units, rapid and effective series production of holder pages that are ready for binding is possible, and even a subsequent binding operation for the booklets containing the holder pages, as an automated manufacturing process.

According to one preferred embodiment, the through-holes are punched out as slots in the sheet of card one after the other or at the same time. This permits simple and rapid production of the through-holes which will subsequently form the hinges of the holder pages.

In addition to the dividing operation which is carried out transversely to the longitudinal direction of the web, the composite may be cut parallel to the longitudinal direction of the web along side edges of the printed units, in order to remove web edges which do not belong to an actual printed unit and which are undesirable in the resulting holder pages. Of course, such dividing operations may be carried out both in the longitudinal direction and in the transverse direction of the web in the form of a joint punching operation.

Alternatively, a method for the series production of identification pages for bound documents, in particular for passports and/or identity papers, may comprise the following steps:
providing a printed web of printable material comprising a plurality of printed units which are arranged in at least one row;
dividing the printed web between the printed units arranged in rows into individual printed web units;
arranging in rows the individual printed web units at predefinable spacings;
arranging in layers a first, lower film-type web, the individual printed web units arranged in rows and a second, upper film-type web;
laminating the webs and web units arranged in layers so as to form a composite; and
dividing the composite between the web units arranged in rows into individual composite units, such that each composite unit has along at least one of its sides a strip which does not comprise any part of the printed web.

In such a method, the printed units are separated from one another prior to the actual laminating operation, so that the printed units can be arranged in rows at individually different spacings from one another, in order thus to be formed with side strips of different width which act as hinges. In this way, either strips with a very large width can be produced or else printed units can be arranged at a distance from one another in such a way that the distance corresponds to twice the width of a strip that is subsequently to be produced, so that the strips of two holder pages that are adjacent to one another face towards one another prior to the dividing operation.

Preferably, a plurality of antennas based on the RFID principle are integrated in the printed web before or during the production of a composition, wherein said antennas are assigned to the individual printed units. Such antennas are used for data exchange with, or for a process for reading stored data by means of, an external data exchange and reading device. Of course, as an alternative or in addition, magnetic strips or electronic microcircuits, such as semiconductor chips for example, may be arranged in such holder pages. The provision of such additional elements may be automatically integrated in the series production of the holder pages by the method according to the invention, without having to interrupt the series production process for this.

The operation of dividing the composite may comprise either a punching operation or a cutting operation.

The film-type webs are made of a light-transparent material and preferably consist of a terephthalate mixture which has a high level of durability in the event of frequent bending of the holder page within the booklet. This occurs in particular when a fold is additionally formed parallel to a seam of the booklet at the strip of the holder page, so that the holder page is bent in the region of the fold and not in the region of the seam.

An identification page, such as a holder page, for bound documents, in particular for passports and/or identity papers, is advantageously produced by the method steps according to the invention. It may accordingly consist of at least one first, lower film-type layer, at least one layer which is optionally printed on one or both sides, which is made for example from a paper material, and at least one second, upper film-type layer, wherein the holder page has on at least one side a laminated strip for fixing it in the document, for example by sewing. This strip is composed of the first and second film-type layers without any intermediate printed layer.

A bound document, such as a booklet comprising a plurality of printed pages and such a holder page, is joined to the holder page in such a way that the latter is sewn into the document or glued into the document by means of its strip produced according to the invention.

Further preferred embodiments emerge from the dependent claims.

Advantages and expedient features can be found in the following description in conjunction with the drawing:

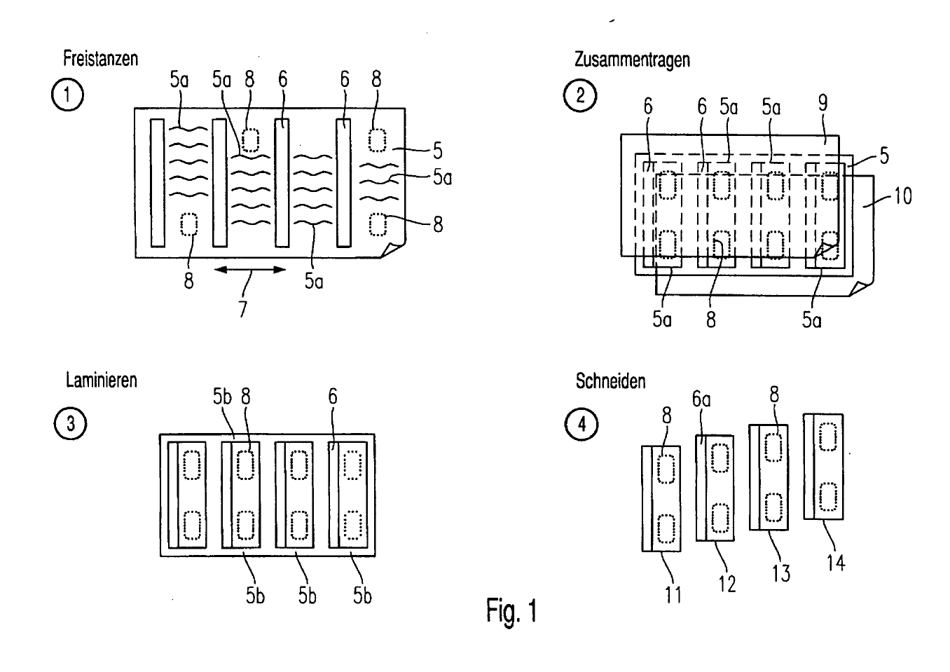

FIG. 1 shows a schematic diagram of a first embodiment of the method according to the invention;

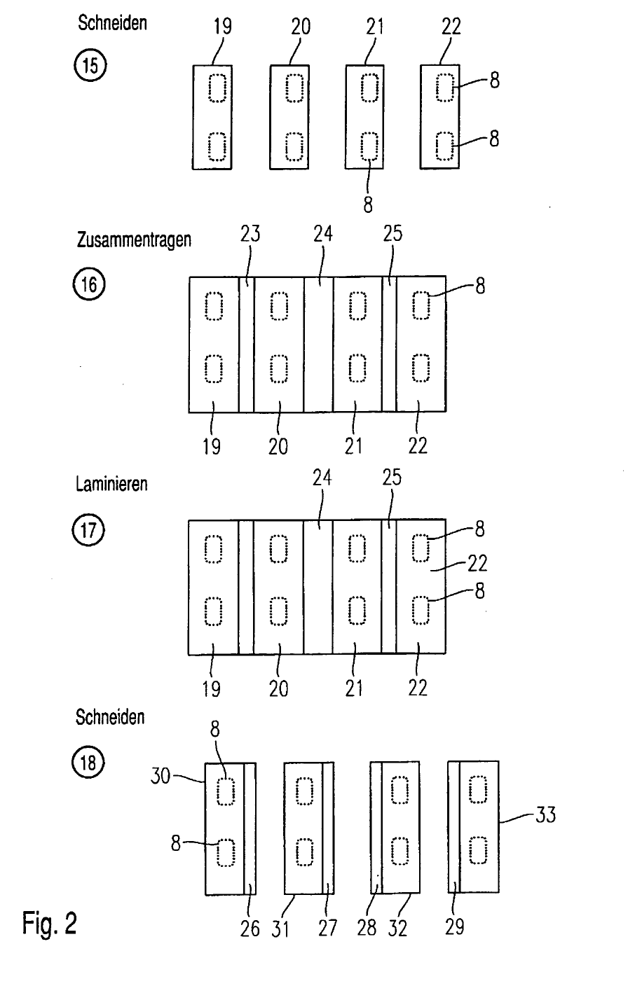

FIG. 2 shows a schematic diagram of a second embodiment of the method according to the invention;

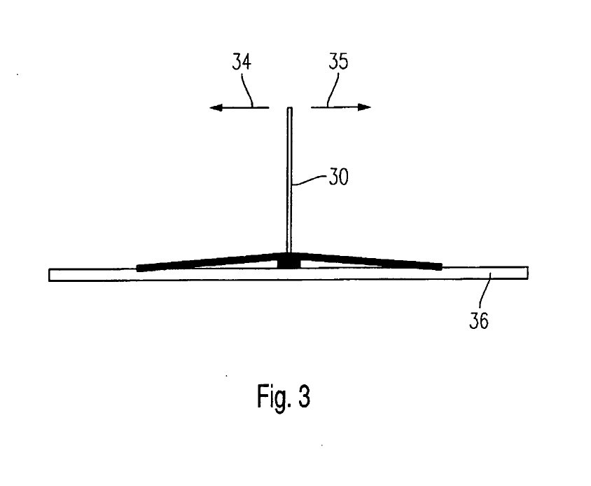

FIG. 3 shows, in a side view, a schematic diagram of a durability test which can be carried out for a holder page produced by the method according to the invention and sewn into a booklet.

FIG. 1 shows a schematic diagram of the method according to the invention in a first embodiment. In a step 1, firstly slot-shaped holes 6 which are designed as through-holes are punched out of a sheet of card 5 comprising a plurality of printed units 5a which are arranged in two rows, wherein each row contains four printed units arranged one behind the other.

The web 5 can be displaced along its longitudinal direction, as shown by the double arrow 7, within a device for the series production of holder pages, in order to be able to carry out simultaneous or sequential method steps on the individual printed units 5.

Each printed unit is assigned an antenna 8, which is shown schematically here.

In a step 2, the sheet of card is automatically brought together with a first, lower film 10 and a second, upper film 9, which preferably have the same dimensions as the sheet of card, in order to be able to carry out, in a step 3, an operation of laminating the sheet of card with the films designed as hinge films, preferably by heating such a layered structure. During such a laminating operation, the lower and upper films are welded together in the region of the slot-shaped through-holes 6, without any part of the printed sheet of card being arranged therebetween. Such a laminating operation results in a composite which has side edges 5b of the individual printed units 5a running in the longitudinal direction.

In a step 4, the composite is cut or punched perpendicular to the longitudinal direction 7 to form individual composite parts 11, 12, 13 and 14, in such a way that a strip 6a of film material is arranged at the side of each composite part 11-14 forming a holder page, in order to sew the latter into the booklet.

FIG. 2 shows a schematic diagram of the method according to the invention in a second embodiment of the invention. As can be seen from this diagram, individual printed web units 19, 20, 21 and 22 are obtained in a step 15 by a cutting operation carried out on an initially provided printed sheet of card. In a step 16, these individual web units 19-22 are arranged in rows parallel to one another at a specific spacing 23, 24 and 25 and are arranged as a layer with a film (not shown here) covering them from above and below.

In a step 17, a laminating operation once again takes place, in which the spacings 23, 24 and 25 are formed as regions in which there is no printed web part.

In a step 18, a cutting operation takes place which separates the printed units or web units 19-22, which are arranged in two rows, from one another in such a way that, on each composite part 30, 31, 32 and 33 obtained from such a composite, there is a lateral strip 26, 27, 28 and 29 which does not comprise any part of the printed sheet of card. To this end, the spacing 24 is selected at the start with a dimension such that it is twice the width of a strip 27, 28 that is subsequently to be produced. The cutting operation is thus carried out between the composite parts 31 and 32 in the centre of the spacing 24.

FIG. 3 shows a schematic diagram of a side view of a structure for carrying out a durability test. Such a durability test for testing the durability of a holder page produced according to the invention, which is sewn into a booklet by means of its lateral strip made of a hinge film, is characterized in that the holder page is moved through 180° from left to right and back again, as shown by the arrows 34 and 35, until first breaks in the region of the hinge film can be detected. To this end, the booklet is clamped on a bending device 36.

Such a test has shown that only after approx. 40,000 back-and-forth movements do small tears occur in the hinge films.

Such a test may additionally be combined with a temperature change test such that firstly the booklet is placed at a temperature of −40° C. for 15 hours and then a considerable temperature increase up to 80° C. is carried out. In this case, it has been shown that the durability of the holder page produced according to the invention is reduced only insignificantly compared to the tests carried out under normal temperature conditions.

All of the features disclosed in the application documents are claimed as essential to the invention in so far as they are novel either individually or in combination with one another with respect to the prior art. All of the features disclosed in the application documents are claimed as essential to the invention both individually and in combination with one another. Modifications thereto are known to the person skilled in the art.

### LIST OF REFERENCES

1 step of punching out
2 step of bringing together
3 step of lamination
4 step of cutting
5 sheet of card
5a printed units
5b side edges
6 slot-shaped through-holes
6a receiving element
7 longitudinal direction of the sheet of card
8 antennas
9 upper hinge film
10 lower hinge film
11, 12, 13, 14 holder pages, composite parts
15 step of cutting into individual web units
16 step of bringing the web units together
17 step of lamination
18 step of cutting
19, 20, 21, 22 web units
23, 24, 25 spacings between the web units
26, 27, 28, 29 strips of the composite parts/holder pages
30, 31, 32, 33 composite parts
34, 35 bending movement direction
36 bending device

1. Method for the series production of identification pages for bound documents, in particular for passports and/or identity papers, characterized by the following steps:
providing a printed web of printed material comprising a plurality of printed units which are arranged in at least one row;
forming slot-shaped through-holes in the printed web, said through-holes running between the printed units perpendicular to the longitudinal direction of the web;
arranging in layers at least one first, lower film-type web, the printed web and at least one second, upper film-type web;
laminating the webs arranged in layers so as to form a composite; and
dividing the composite between the printed units arranged in rows into individual composite units, such that each composite unit has along at least one of its sides a strip (6a) which does not comprise any part of the printed web.

2. Method according to claim 1, characterized in that the through-holes are punched out one after the other or at the same time.

3. Method according to claim 1, characterized in that the composite is additionally cut in the longitudinal direction of the webs in order to remove undesirable web edges.

4. Method for the series production of identification pages for bound documents, in particular for passports and/or identity papers, characterized by the following steps:
providing a printed web of printable material comprising a plurality of printed units which are arranged in at least one row;
dividing the printed web between the printed units arranged in rows into individual printed web units;
arranging in rows the individual printed web units at predefinable spacings;
arranging in layers a first, lower film-type web, the individual printed web units arranged in rows and a second, upper film-type web;
laminating the webs and web units arranged in layers so as to form a composite; and
dividing the composite between the web units arranged in rows into individual composite units, such that each composite unit has along at least one of its sides a strip which does not comprise any part of the printed web.

5. Method according to claim 4, characterized in that the width of the strip corresponds to the width of the spacing.

6. Method according to claim 4, characterized in that the width of the strip corresponds to half the width of the spacing.

7. Method according to claim 4, characterized in that a plurality of antennas based on the RFID principle, which are assigned to the individual printed units, are integrated in the printed web at the start.

8. Method according to claim 4, characterized in that the dividing of the composite into individual composite parts comprises a cutting operation.

9. Method according to claim 4, characterized in that the dividing of the composite into individual composite parts comprises a punching operation.

10. Method according to claim 4, characterized in that the film-type webs are made of a light-transparent material.

11. Identification page for bound documents, in particular for passports and/or identity papers, which is produced by a method according to claim 1.

12. Identification page for bound documents, in particular for passports and/or identity papers, comprising at least one first, lower film-type layer, a layer which is optionally printed on one or both sides, and at least one second, upper film-type layer, wherein the identification page has on at least one side a laminated strip for fixing it in the document, said strip being composed of the first and second film-type layers and without the printed layer.

13. Identification page according to claim 12, characterized in that the film-type layer is made from a polybutylene/terephthalate mixture.

14. Bound document, in particular passport and/or identity papers, comprising a plurality of printed pages and one identification page, characterized in that the identification page is sewn into the document or glued into the document at a laterally arranged strip made of film-type material.

15. Method according to claim 1, characterized in that the width of the strip corresponds to the width of the slot-shaped through-hole.

16. Method according to claim 1, characterized in that the width of the strip corresponds to half the width of the slot-shaped through-hole of the spacing.

17. Method according to claim 1, characterized in that a plurality of antennas based on the RFID principle, which are assigned to the individual printed units, are integrated in the printed web at the start.

18. Method according to claim 4, characterized in that the dividing of the composite into individual composite parts comprises a cutting operation.

19. Method according to claim 1, characterized in that the dividing of the composite into individual composite parts comprises a punching operation.

20. Method according to claim 1, characterized in that the film-type webs are made of a light-transparent material.
